(19) United States
(12) Patent Application Publication
(10) Pub. No.: US 2015/0000086 A1
(43) Pub. Date: Jan. 1, 2015

(54) VEHICLE SUBSTRATE HAVING A POCKET FOR ISOLATING A FASTENER

(71) Applicant: GM Global Technology Operations LLC, Detroit, MI (US)

(72) Inventors: Robert N. Saje, SHELBY TOWNSHIP, MI (US); ROBERT M. KIELBIK, CHESTERFIELD TOWNSHIP, MI (US)

(73) Assignee: GM Global Technology Operations LLC, Detroit, MI (US)

(21) Appl. No.: 14/287,535

(22) Filed: May 27, 2014

Related U.S. Application Data
(60) Provisional application No. 61/841,028, filed on Jun. 28, 2013.

(51) Int. Cl. F16B 19/00

(52) U.S. Cl. CPC F16B 19/00
USPC 24/289; 29/525.01; 29/525.11

(57) ABSTRACT

A number of variations may include a product including a vehicle substrate having a pocket formed therein for isolating a fastener.

### CROSS-REFERENCE TO RELATED APPLICATIONS

This application claims the benefit of U.S. Provisional Application No. 61/841,028 filed Jun. 28, 2013.

The field to which the disclosure generally relates to includes substrates for vehicles and methods of making and using the same.

### BACKGROUND

Vehicles may include two or more substrates joined together to make a component of the vehicle.

### SUMMARY OF ILLUSTRATIVE VARIATIONS

A number of variations may include a product including a vehicle substrate having a pocket formed therein for isolating a fastener.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

FIG. 1 is a perspective view of a product which may include a first vehicle substrate including a plurality of pockets each for isolating a fastener according to a number of variations.

FIG. 2 is a partial plan view of a product which may include one face of the first vehicle substrate having a pocket formed therein and a second vehicle substrate attached to the first vehicle substrate by a fastener having a portion received in the pocket according to a number of variations.

FIG. 3 is a partial plan view of the opposite face of the first vehicle substrate having a raised structure including a plurality of walls which define the pocket formed in the opposite face of the first vehicle substrate.

Select examples of variations within the scope of the invention will become more fully understood from the detailed description and the accompanying drawings, wherein:

### DETAILED DESCRIPTION OF ILLUSTRATIVE VARIATIONS

The following description of the variations is merely illustrative in nature and is in no way intended to limit the scope of the invention, its application, or uses.

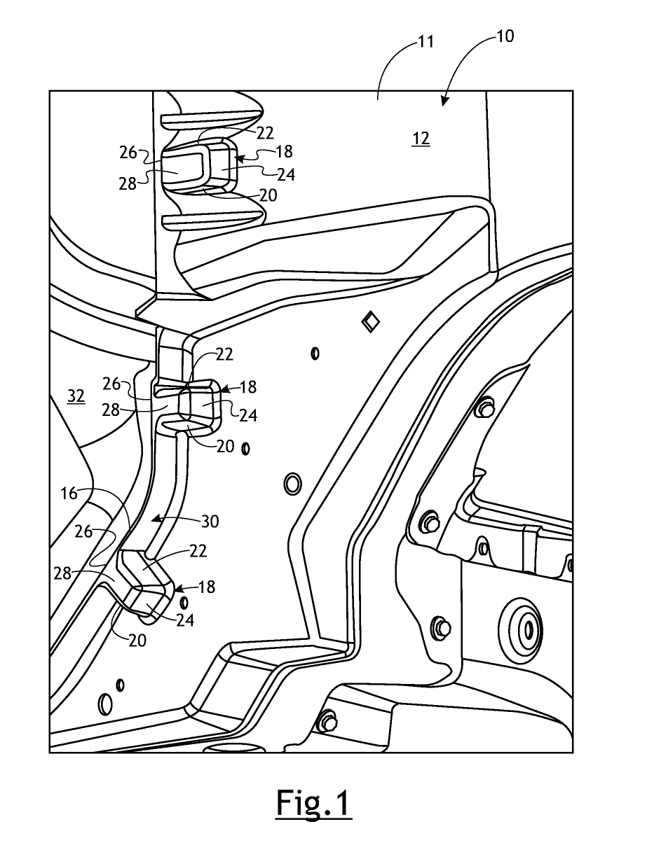

FIGS. 1-3 illustrate a number of variations which may include a product 10 which may include a first vehicle substrate 11 having a first face 12 and an opposite second face 14. The first vehicle substrate 11 may include an edge 16 and a plurality of raised features 18 having a plurality of walls which define a pocket 19 in the opposite second face 14. The raised structure 18 may include a first side wall 20 and opposite second side wall 22, a first end wall 24 and opposite second end wall 26, and a bottom wall 28. The raised structures 18 may be provided near an overlap portion 30 of the first substrate 11 which overlaps a portion of a second substrate 32. In a number of variations the second end wall 36 may be a portion of the overlap portion 30.

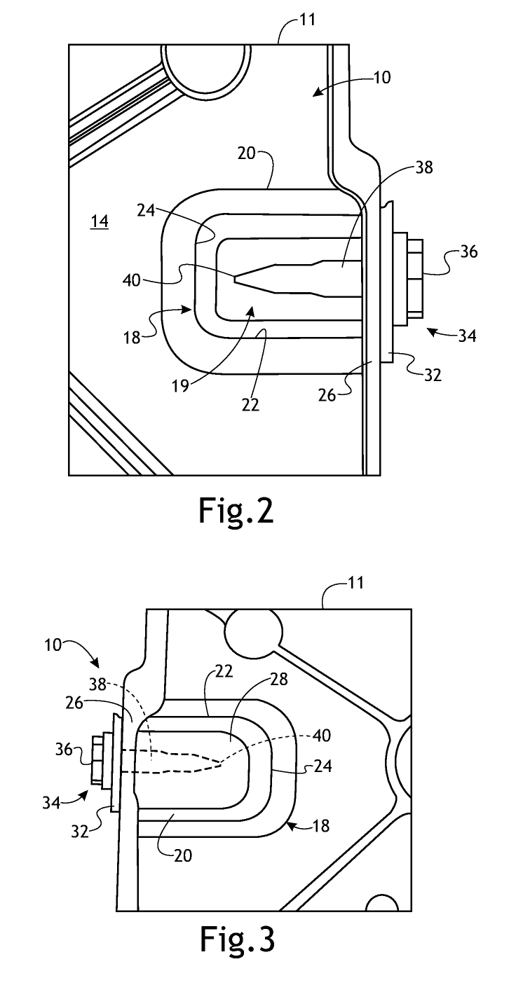

Referring now to FIGS. 2-3, in a number of variations, a pocket 19 may be formed in the second face 14 of the substrate 11 by the first side wall 20 and opposite second side wall 22, first end wall 24 and opposite second end wall 26, and the bottom wall 28. However, the pocket 18 may be of any shape and is not limited to the design illustrated in FIG. 2. The second substrate 32 may be attached to the first substrate 11 by a fastener 34 having a portion received in the pocket 19. In a number of variations, the fastener 34 may be a flow drill screw having a head 36 attached to a shaft 38 which has a pointed end 40.

In a number of variations the first vehicle substrate 11 may be made from a first material and wherein the second vehicle substrate 32 may be made from the second material, and wherein the first material and second material may not be welded together. In a number of variations, the first substrate 11 may be made from any of a variety of materials. In a number of variations, the first substrate 11 may be a cast substrate, for example, but not limited to, a high pressure die casting comprising an aluminum alloy. The first cast substrate may be produced by casting an aluminum alloy under high pressures, for example, but not limited to, pressures of 500-2500 tons or greater. A number of variations, the second substrate 32 may be made from a variety of materials comprising, but not limited to, steel, aluminum or an alloy other than aluminum.

The substrate 11 including pockets 19 formed therein may be utilized to isolate an attachment feature used to attach different materials together such as aluminum substrates and steel substrates. The pocket 19 prevents the sharp fastener 40 from contacting vehicle occupants and/or other vehicle components. When the substrate 11 is a cast component having the pocket integrally formed in the casting, additional parts do not have to be assembled to the substrate to isolate the fastener.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: a first vehicle substrate having a first face and an opposite second face, the first vehicle substrate having a first edge and an overlap portion near the first edge and at least one fastener isolation pocket formed in the first face.

Variation 2 may include a product as set forth in Variation 1 wherein the at least one fastener isolation pocket comprises a plurality of fastener isolation pockets each formed in the first face near the first edge.

Variation 3 may include a product as set forth in any of Variations 1-2 wherein the first vehicle substrate comprises a cast material.

Variation 4 may include a product as set forth in any of Variations 1-3 wherein the at least one fastener isolation pocket is defined by a plurality of walls, and wherein one of the walls is a portion of the overlap portion.

Variation 5 may include a product as set forth in any of Variations 2-4 wherein each of the plurality of fastener isolation pockets is constructed and arranged to isolate a single fastener.

Variation 6 may include a product as set forth in any of Variations 2-5 wherein each of the plurality of fastener isolation pockets is defined by a first side wall and second opposite side wall, first end wall and second opposite end wall, and a bottom wall.

Variation 7 may include a product as set forth in any of Variations 1-6 wherein the second end wall is a portion of the overlap portion.

Variation 8 may include a product as set forth in any of Variations 1-7 further comprising a second vehicle substrate having a portion overlapping the overlap portion of the first vehicle substrate, and a fastener extending through the portion of the second vehicle substrate overlapping the overlap portion of the first substrate, through the first vehicle substrate and having a portion of the fastener received in one of the plurality of fastener isolation pockets.

Variation 9 may include a product as set forth in any of Variations 1-8 wherein the fastener is a flow drill screw having a head attached to a shaft, and wherein the shaft includes a pointed end, and wherein a portion of the shaft and the pointed end is received in one of the plurality of fastener isolation pockets.

Variation 10 may include a product as set forth in any of Variations 1-9 wherein the second vehicle substrate comprises steel.

Variation 11 may include a product as set forth in any of Variations 1-10 wherein the first vehicle substrate is made from a first material and wherein the second vehicle substrate is made from the second material and wherein the first material and second material cannot be welded together.

Variation 12 may include a method comprising: casting a first vehicle substrate having a first face and an opposite second face, the first vehicle substrate having a first edge and an overlap portion near the first edge and at least one fastener isolation pocket formed in the first face.

Variation 13 may include a product as set forth in Variation 12 wherein the at least one fastener isolation pocket comprises a plurality of fastener isolation pockets each formed in the first vehicle substrate near the first edge.

Variation 14 may include a method comprising: providing a first vehicle substrate having a first face and an opposite second face, the first vehicle substrate having a first edge and an overlap portion near the first edge and at least one fastener isolation pocket formed in the first face; placing a portion of second vehicle substrate over the overlap portion; inserting a first fastener through the portion of the second vehicle substrate overlying the overlap portion and through the first vehicle substrate so that the a portion of the first fastener is received in the at least one fastener isolation pocket.

Variation 15 may include a product as set forth in any of Variations 12-14 wherein the first vehicle substrate is made from a cast metal.

Variation 16 may include a product as set forth in any of Variations 12-15 wherein the second vehicle substrate comprises steel.

Variation 17 may include a product as set forth in any of Variations 12-16 wherein the first fastener is a flow drill screw including a head and a shaft extending from the head and wherein the shaft includes a pointed end, and wherein the portion of the first fastener is a portion of the shaft and the pointed that is received in the at least one fastener isolation pocket.

Variation 18 may include a product as set forth in any of Variations 12-17 wherein the at least one fastener isolation pocket comprises a plurality of fastener isolation pockets each formed in the first vehicle substrate near the first edge.

Variation 19 may include a product as set forth in any of Variations 12-18 wherein each of the plurality of fastener isolation pockets is defined by a first side wall and second opposite side wall, first end wall and second opposite end wall, and a bottom wall.

Variation 20 may include a product as set forth in any of Variations 12-19 wherein the providing comprises high pressure casting the first vehicle substrate from an aluminum alloy.

The above description of select variations within the scope of the invention is merely illustrative in nature and, thus, variations or variants thereof are not to be regarded as a departure from the spirit and scope of the invention.

What is claimed is:

1. A product comprising:
a first vehicle substrate having a first face and an opposite second face, the first vehicle substrate having a first edge and an overlap portion near the first edge and at least one fastener isolation pocket formed in the first face.

2. A product as set forth in claim 1 wherein the at least one fastener isolation pocket comprises a plurality of fastener isolation pockets each formed in the first face near the first edge.

3. A product as set forth in claim 1 wherein the first vehicle substrate comprises a cast material.

4. A product as set forth in claim 1 wherein the at least one fastener isolation pocket is defined by a plurality of walls, and wherein one of the walls is a portion of the overlap portion.

5. A product as set forth in claim 2 wherein each of the plurality of fastener isolation pockets is constructed and arranged to isolate a single fastener.

6. A product as set forth in claim 2 wherein each of the plurality of fastener isolation pockets is defined by a first side wall and second opposite side wall, first end wall and second opposite end wall, and a bottom wall.

7. A product as set forth in claim 6 wherein the second end wall is a portion of the overlap portion.

8. A product as set forth in claim 1 further comprising a second vehicle substrate having a portion overlapping the overlap portion of the first vehicle substrate, and a fastener extending through the portion of the second vehicle substrate overlapping the overlap portion of the first substrate and through the first vehicle substrate and having a portion of the fastener received in the at least one fastener isolation pocket.

9. A product as set forth in claim 8 wherein the fastener is a flow drill screw having a head attached to a shaft, and wherein the shaft includes a pointed end, and wherein a portion of the shaft and the pointed end is received in the at least one fastener isolation pocket.

10. A product as set forth in claim 8 wherein the second vehicle substrate comprises steel.

11. A product as set forth in claim 8 wherein the first vehicle substrate is made from a first material and wherein the second vehicle substrate is made from the second material and wherein the first material and second material cannot be welded together.

12. A method comprising:
casting a first vehicle substrate having a first face and an opposite second face, the first vehicle substrate first edge and an overlap portion near the first edge and at least one fastener isolation pocket formed in the first face.

13. A method as set forth in claim 12 wherein the at least one fastener isolation pocket comprises a plurality of fastener isolation pockets each formed in the first vehicle substrate near the first edge.

14. A method comprising:
providing a first vehicle substrate having a first face and an opposite second face, the first vehicle substrate having a first edge and an overlap portion near the first edge, and at least one fastener isolation pocket formed in the first face;
placing a portion of second vehicle substrate over the overlap portion;
inserting a first fastener through the portion of the second vehicle substrate overlying the overlap portion and through the first vehicle substrate so that the a portion of the first fastener is received in the at least one fastener isolation pocket.

15. A method as set forth in claim 14 wherein the first vehicle substrate is made from a cast metal.

16. A method as set forth in claim 15 wherein the second vehicle substrate comprises steel.

17. A method as set forth in claim 14 wherein the first fastener is a flow drill screw including a head and a shaft extending from the head and wherein the shaft includes a pointed end, and wherein the portion of the first fastener is a portion of the shaft and the pointed that is received in the at least one fastener isolation pocket.

18. A method as set forth in claim 14 wherein the at least one fastener isolation pocket comprises a plurality of fastener isolation pockets each formed in the first vehicle substrate near the first edge.

19. A method as set forth in claim 18 wherein each of the plurality of fastener isolation pockets is defined by a first side wall and second opposite side wall, first end wall and second opposite end wall, and a bottom wall.

20. A method as set forth in claim 14 wherein the providing comprises high pressure casting the first vehicle substrate from an aluminum alloy.
